(19) United States
(12) Patent Application Publication
(10) Pub. No.: US 2012/0058267 A1
(43) Pub. Date: Mar. 8, 2012

(54) Coating Process for Water-Absorbing Polymer Particles

(75) Inventors: Uwe Stueven, Bad Soden (DE); Rüdiger Funk, Niedernhausen (DE); Matthias Weismantel, Jossgrund-Oberndorf (DE); Holger Barthel, Oftersheim (DE); Oskar Stephan, Hockenheim (DE)

(73) Assignee: BASF SE, Ludwigshafen (DE)

(21) Appl. No.: 13/319,544

(22) PCT Filed: May 10, 2010
(86) PCT No.: PCT/EP2010/056316

§ 371 Date: Nov. 9, 2011

(30) Foreign Application Priority Data
May 18, 2009 (EP) 091605238

(51) Int. Cl. B05D 7/02

(52) U.S. Cl. 427/222

(57) ABSTRACT

A coating process wherein an aqueous liquid is sprayed onto surface postcrosslinked water-absorbing polymer particles in a horizontal mixer and the inner wall of the horizontal mixer which is in contact with the product is made from a stainless steel.

The invention relates to a coating process wherein an aqueous liquid is sprayed onto surface postcrosslinked water-absorbing polymer particles in a horizontal mixer and the inner wall of the horizontal mixer which is in contact with the product is made from a stainless steel.

Water-absorbing polymer particles are used to produce diapers, tampons, sanitary napkins and other hygiene articles, but also as water-retaining agents in market gardening. The water-absorbing polymer particles are also referred to as superabsorbents.

The production of water-absorbing polymer particles is described in the monograph “Modern Superabsorbent Polymer Technology”, F. L. Buchholz and A. T. Graham, Wiley-VCH, 1998, pages 71 to 103.

The properties of the water-absorbing polymer particles can be adjusted, for example, via the amount of crosslinker used. With increasing amount of crosslinker, the centrifuge retention capacity (CRC) falls and the absorption under a pressure of 21.0 g/cm² (AUL0.3 psi) passes through a maximum.

To improve the application properties, for example permeability of the swollen gel bed (SFC) in the diaper and absorption under a pressure of 63.0 g/cm² (AUL0.9 psi), water-absorbing polymer particles are generally surface postcrosslinked. This increases the degree of crosslinking of the particle surface, which allows the absorption under a pressure of 63.0 g/cm² (AUL0.9 psi) and the centrifuge retention capacity (CRC) to be at least partly decoupled. This surface postcrosslinking can be performed in the aqueous gel phase. Preferably, however, dried, ground and sieved-off polymer particles (base polymer) are surface coated with a surface postcrosslinker, thermally surface postcrosslinked and dried. Crosslinkers suitable for this purpose are compounds which can form covalent bonds with at least two carboxylate groups of the water-absorbing polymer particles.

The surface postcrosslinkers are typically applied to the base polymer as an aqueous solution. However, the water applied to the particle surface diffuses only slowly into the particle interior. At the same time, the water lowers the glass transition temperature of the polymers; the particle surface becomes tacky. Therefore, when the aqueous solution of the surface postcrosslinker is mixed into the base polymer, undesired agglomerates and caking can arise. To solve this problem, the use of high-speed mixers with water-repellent coatings is proposed, for example in EP 0 450 923 A2 and DE 10 2004 026 934 A1.

After the thermal surface postcrosslinking, the water-absorbing polymer particles often have a moisture content of less than 1% by weight. This increases the tendency of the polymer particles to static charging. The static charging of the polymer particles influences the dosage accuracy, for example in diaper production. This problem is typically solved by establishing a defined moisture content by adding water or aqueous solutions (remoisturizing).

Processes for remoisturizing are disclosed, for example, in WO 98/49221 A1 and EP 0 780 424 A1.

To further improve the permeability (SFC), the particle surface can be modified further, for example by coating with inorganic inert substances, cationic polymers and/or solutions of polyvalent metal cations.

Such coatings are described, for example, in WO 2008/113788 A2, WO 2008/113789 A1 and WO 2008/113790 A1.

It was an object of the present invention to provide an improved process for coating surface postcrosslinked water-absorbing polymer particles with water or aqueous solutions, especially a homogeneous coating, a low dust content and few agglomerates.

The object is achieved by a process for preparing water-absorbing polymer particles by polymerizing a monomer solution or suspension comprising
a) at least one ethylenically unsaturated monomer which bears acid groups and may be at least partly neutralized,
b) at least one crosslinker,
c) at least one initiator,
d) optionally one or more ethylenically unsaturated monomers copolymerizable with the monomers mentioned under a) and
e) optionally one or more water-soluble polymers,
   comprising drying, grinding, classifying and surface postcrosslinking, an aqueous liquid being sprayed onto the surface postcrosslinked water-absorbing polymer particles by means of at least one spray nozzle in a continuous horizontal mixer with moving mixing tools, wherein the inner wall of the mixer which is in contact with the product has a contact angle of less than 80° with respect to water.

Mixers with rotating mixing tools are subdivided into vertical mixers and horizontal mixers according to the position of the axis of rotation.

Horizontal mixers in the context of this invention are mixers with rotating mixing tools whose position of the axis of rotation toward the product flow direction deviates from the horizontal by less than 20°, preferably by less than 15°, more preferably by less than 10°, most preferably by less than 5°.

In the process according to the invention, it is possible to use all horizontal mixers with moving mixing tools known to those skilled in the art, such as screw mixers, disk mixers, plowshare mixers, paddle mixers, helical ribbon mixers and continuous flow mixers. The aqueous liquid can be sprayed on either in high-speed mixers or in mixers with low stirrer speed. A preferred horizontal mixer is the continuous flow mixer.

The inner wall of the mixer has, with respect to water, a contact angle of preferably less than 70°, more preferably of less than 60°, most preferably of less than 50°. The contact angle is a measure of the wetting behavior and is measured to DIN 53900.

Advantageously, in the process according to the invention, mixers whose inner wall which is in contact with the product is made of a stainless steel are used. Stainless steels typically have a chromium content of 10.5 to 13% by weight of chromium. The high chromium content leads to a protective passivation composed of chromium dioxide on the steel surface. Further alloy constituents increase the corrosion resistance and improve the mechanical properties.

Particularly suitable steels are austenitic steels with, for example, at least 0.08% by weight of carbon. Advantageously, the austenitic steels comprise, as well as iron, carbon, chromium, nickel and optionally molybdenum, further alloy constituents, preferably niobium or titanium.

The preferred stainless steels are steels with materials number 1.45xx according to DIN EN 10020, where xx may be a natural number between 0 and 99. Particularly preferred materials are the steels with materials numbers 1.4541 and 1.4571, especially steel with materials number 1.4571.

Advantageously, the inner wall of the mixer which is in contact with the product is polished. Polished stainless steel surfaces have a lower roughness and a lower contact angle with respect to water than matt or roughened steel surfaces.

The present invention is based on the finding that surface nonpostcrosslinked water-absorbing polymer particles (base polymer) and surface postcrosslinked water-absorbing polymer particles have significantly different behavior when mixed with aqueous liquids.

On addition of water, the tack of surface postcrosslinked water-absorbing polymer particles possibly increases less significantly than the tack of surface nonpostcrosslinked water-absorbing polymer particles (base polymer). Therefore, the use of mixers with water-repellent inner surfaces in the coating of surface postcrosslinked water-absorbing polymer particles is unnecessary; there is typically no risk of caking.

Moreover, small water droplets on water-repellent surfaces can combine more easily to form larger droplets. This possibly leads to an inhomogeneous distribution of the aqueous liquid.

The temperature of the water-absorbing polymer particles fed to the mixer is preferably from 40 to 80° C., more preferably from 45 to 75° C., most preferably from 50 to 70° C.

The residence time in the mixer is preferably from 1 to 180 minutes, more preferably from 2 to 60 minutes, most preferably from 5 to 20 minutes.

The peripheral speed of the mixing tools is preferably from 0.1 to 10 m/s, more preferably from 0.5 to 5 m/s, most preferably from 0.75 to 2.5 m/s.

The surface postcrosslinked water-absorbing polymer particles are moved in the mixer at a speed which corresponds to a Froude number of preferably 0.01 to 6, more preferably 0.05 to 3, most preferably 0.1 to 0.7.

For mixers with horizontally mounted mixing tools, the Froude number is defined as follows:

$$Fr = \frac{{ω}^{2} r}{g}$$

where
r: radius of the mixing tool
ω: angular frequency
g: acceleration due to gravity.

The fill level of the mixer is preferably from 30 to 80%, more preferably from 40 to 75%, most preferably from 50 to 70%.

The aqueous liquid is preferably sprayed on by means of a two-substance nozzle, more preferably by means of an internally mixing two-substance nozzle.

Two-substance nozzles enable atomization into fine droplets or a spray mist. The atomization form employed is a circular or else elliptical solid or hollow cone. Two-substance nozzles may be configured with external mixing or internal mixing. In the case of the externally mixing two-substance nozzles, liquid and atomizer gas leave the nozzle head through separate orifices. They are mixed in the spray jet only after leaving the spray nozzle. This enables independent regulation of droplet size distribution and throughput over a wide range. The spray cone of the spray nozzle can be adjusted via the air flap setting. In the case of the internally mixing two-substance nozzle, liquid and atomizer gas are mixed within the spray nozzle and the biphasic mixture leaves the nozzle head through the same bore (or through a plurality of parallel bores). In the case of the internally mixing two-substance nozzle, the quantitative ratios and pressure conditions are more highly coupled than in the case of the externally mixing spray nozzle. Small changes in the throughput therefore lead to a change in the droplet size distribution. The adjustment to the desired throughput is effected through the selected cross section of the nozzle bore.

Useful atomizer gases include compressed air, nitrogen or steam of 0.5 bar and more. The droplet size can be adjusted individually via the ratio of liquid to atomizer gas, and also gas and liquid pressure.

In a particularly preferred embodiment, the liquid is sprayed below the product bed surface of the moving polymer particle layer, preferably at least 10 mm, more preferably at least 50 mm, most preferably at least 100 mm, i.e. the spray nozzle is immersed into the product bed.

The product bed surface is the interface which is established between the surface postcrosslinked water-absorbing polymer particles which are moved within the mixer and the blanketing atmosphere.

In the horizontal mixer, the angle between the mixer axis and the feed to the spray nozzle is preferably approx. 90°. The liquid can be supplied vertically from above. A feed obliquely from the side is likewise possible, in which case the angle relative to the vertical is preferably between 60 and 90°, more preferably between 70 and 85°, most preferably between 75 and 82.5°. The oblique arrangement of the feed enables the use of shorter feeds and hence lower mechanical stresses during the operation of the mixer.

In a particularly preferred embodiment, the spray nozzle is below the axis of rotation and sprays in the direction of rotation. By virtue of this arrangement, the coated water-absorbing polymer particles are conveyed optimally away from the spray nozzle. In combination with the oblique arrangement, it is also possible to exchange the spray nozzle during the operation of the mixer, without product escaping.

In a further preferred embodiment of the present invention, at least one spray nozzle is thermally insulated and/or trace-heated.

“Thermally insulated” means that the outer surface of the spray nozzle at least partly has a further material layer, the material of said further material layer having a lower thermal conductivity than the material of the spray nozzle. The thermal conductivity of the material of the further material layer at 20° C. is preferably less than 2 Wm⁻¹K⁻¹, more preferably less than 0.5 Wm⁻¹K⁻¹, most preferably less than 0.1 Wm⁻¹K⁻¹.

“Trace-heated” means that thermal energy is additionally supplied to the spray nozzle, for example by means of electrical energy or by means of a heating jacket through which a heat carrier flows. Suitable heat carriers are commercial heat carrier oils, such as Marlotherm®, steam or hot water.

A possible supply of heat via one of the feedstocks used in the mixing, i.e. surface postcrosslinked water-absorbing polymer particles or liquid to be sprayed, is not trace heating in the context of the present invention.

The temperature of the spray nozzle is preferably from 1 to 20° C., more preferably from 2 to 15° C., most preferably from 5 to 10° C., higher than the temperature of the surface postcrosslinked water-absorbing polymer particles.

In the case of a thermally insulated spray nozzle, the temperature of the liquid to be sprayed is preferably from 1 to 20° C., more preferably from 2 to 15° C., most preferably from 5 to 10° C., higher than the temperature of the surface postcrosslinked water-absorbing polymer particles. The temperature of the liquid to be sprayed corresponds approximately to the temperature of the spray nozzle.

In the case of a trace-heated and optionally thermally insulated spray nozzle, the temperature difference between the surface postcrosslinked water-absorbing polymer particles and the liquid to be sprayed on is preferably less than 20° C., preferentially less than 10° C., more preferably less than 5° C., most preferably less than 2° C.

The temperature difference between the liquid to be sprayed on and the atomizer gas is preferably less than 20° C., preferentially less than 10° C., more preferably less than 5° C., most preferably less than 2° C.

Suitable aqueous liquids are, for example, dispersions of inorganic inert substances, solutions or dispersions of cationic polymers, solutions of di- or polyvalent metal cations, and polyols or solutions thereof. The aqueous liquids for use in accordance with the invention comprise preferably at least 50% by weight, more preferably at least 70% by weight, most preferably at least 90% by weight, of water.

The water-absorbing polymer particles are produced by polymerizing a monomer solution or suspension and are typically water-insoluble.

The monomers a) are preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomers a) typically comprise polymerization inhibitors, preferably hydroquinone monoethers, as storage stabilizers.

The monomer solution comprises preferably up to 250 ppm by weight, preferably at most 130 ppm by weight, more preferably at most 70 ppm by weight, preferably at least 10 ppm by weight, more preferably at least 30 ppm by weight, especially around 50 ppm by weight, of hydroquinone monoether, based in each case on the unneutralized monomer a). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl triallyl ether, tetraalloxyethane, methylenebismethacrylamide, 15-tuply ethoxylated trimethylolpropane triacrylate, polyethylene glycol diacrylate, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably 0.05 to 1.5% by weight, more preferably 0.1 to 1% by weight, most preferably 0.3 to 0.6% by weight, based in each case on monomer a). With rising crosslinker content, the centrifuge retention capacity (CRC) falls and the absorption under a pressure of 21.0 g/cm² passes through a maximum.

The initiators c) used may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite. Such mixtures are obtainable as Brüggolite® FF6 and Brüggolite® FF7 (Brüggemann Chemicals; Heilbronn; Germany).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight, most preferably from 50 to 65% by weight. It is also possible to use monomer suspensions, i.e. monomer solutions with excess monomer a), for example sodium acrylate. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen, and the polymerization inhibitor present in the monomer solution can be deactivated, before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/038402 A1. Polymerization on a belt is described, for example, in DE 38 25 366 A1 and U.S. Pat. No. 6,241,928. Polymerization in a belt reactor forms a polymer gel, which has to be comminuted in a further process step, for example in an extruder or kneader.

However, it is also possible to dropletize an aqueous monomer solution and to polymerize the droplets obtained in a heated carrier gas stream. This allows the process steps of polymerization and drying to be combined, as described in WO 2008/040715 A2 and WO 2008/052971 A1.

The acid groups of the resulting polymer gels have typically been partially neutralized. Neutralization is preferably carried out at the monomer stage. This is typically done by mixing in the neutralizing agent as an aqueous solution or preferably also as a solid. The degree of neutralization is preferably from 25 to 95 mol %, more preferably from 30 to 80 mol %, most preferably from 40 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

However, it is also possible to carry out neutralization after the polymerization, at the stage of the polymer gel formed in the polymerization. It is also possible to neutralize up to 40 mol %, preferably 10 to 30 mol % and more preferably 15 to 25 mol % of the acid groups before the polymerization by adding a portion of the neutralizing agent actually to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

The polymer gel is then preferably dried with a belt drier until the residual moisture content is preferably 0.5 to 15% by weight, more preferably 1 to 10% by weight, most preferably 2 to 8% by weight, the residual moisture content being determined by EDANA recommended test method No. WSP 230.2-05 “Moisture Content”. In the case of too high a residual moisture content, the dried polymer gel has too low a glass transition temperature T_{g} and can be processed further only with difficulty. In the case of too low a residual moisture content, the dried polymer gel is too brittle and, in the subsequent comminution steps, undesirably large amounts of polymer particles with an excessively low particle size (fines) are obtained. The solids content of the gel before the drying is preferably from 25 to 90% by weight, more preferably from 35 to 70% by weight, most preferably from 40 to 60% by weight. Optionally, it is, however, also possible to use a fluidized bed drier or a paddle drier for the drying operation.

Thereafter, the dried polymer gel is ground and classified, and the apparatus used for grinding may typically be single- or multistage roll mills, preferably two- or three-stage roll mills, pin mills, hammer mills or vibratory mills.

The mean particle size of the polymer particles removed as the product fraction is preferably at least 200 μm, more preferably from 250 to 600 μm, very particularly from 300 to 500 μm. The mean particle size of the product fraction may be determined by means of EDANA recommended test method No. WSP 220.2-05 “Particle Size Distribution”, where the proportions by mass of the screen fractions are plotted in cumulative form and the mean particle size is determined graphically. The mean particle size here is the value of the mesh size which gives rise to a cumulative 50% by weight.

The proportion of particles with a particle size of at least 150 μm is preferably at least 90% by weight, more preferably at least 95% by weight, most preferably at least 98% by weight.

Polymer particles with too small a particle size lower the permeability (SFC). The proportion of excessively small polymer particles (fines) should therefore be small.

Excessively small polymer particles are therefore typically removed and recycled into the process. This is preferably done before, during or immediately after the polymerization, i.e. before the drying of the polymer gel. The excessively small polymer particles can be moistened with water and/or aqueous surfactant before or during the recycling.

It is also possible in later process steps to remove excessively small polymer particles, for example after the surface postcrosslinking or another coating step. In this case, the excessively small polymer particles recycled are surface postcrosslinked or coated in another way, for example with fumed silica.

When a kneading reactor is used for polymerization, the excessively small polymer particles are preferably added during the last third of the polymerization.

When the excessively small polymer particles are added at a very early stage, for example actually to the monomer solution, this lowers the centrifuge retention capacity (CRC) of the resulting water-absorbing polymer particles. However, this can be compensated, for example, by adjusting the amount of crosslinker b) used.

When the excessively small polymer particles are added at a very late stage, for example not until an apparatus connected downstream of the polymerization reactor, for example to an extruder, the excessively small polymer particles can be incorporated into the resulting polymer gel only with difficulty. Insufficiently incorporated, excessively small polymer particles are, however, detached again from the dried polymer gel during the grinding, are therefore removed again in the course of classification and increase the amount of excessively small polymer particles to be recycled.

The proportion of particles having a particle size of at most 850 μm is preferably at least 90% by weight, more preferably at least 95% by weight, most preferably at least 98% by weight.

Advantageously, the proportion of particles having a particle size of at most 600 μm is preferably at least 90% by weight, more preferably at least 95% by weight, most preferably at least 98% by weight.

Polymer particles with too great a particle size lower the swell rate. The proportion of excessively large polymer particles should therefore likewise be small.

Excessively large polymer particles are therefore typically removed and recycled into the grinding of the dried polymer gel.

To further improve the properties, the polymer particles are surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amidoamines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or p-hydroxyalkylamides, as described in DE 102 04 938 A1 and U.S. Pat. No. 6,239,230.

Additionally described as suitable surface postcrosslinkers are cyclic carbonates in DE 40 20 780 C1, 2-oxazolidone and its derivatives, such as 2-hydroxyethyl-2-oxazolidone in DE 198 07 502 A1, bis- and poly-2-oxazolidinones in DE 198 07 992 C1, 2-oxotetrahydro-1,3-oxazine and its derivatives in DE 198 54 573 A1, N-acyl-2-oxazolidones in DE 198 54 574 A1, cyclic ureas in DE 102 04 937 A1, bicyclic amide acetals in DE 103 34 584 A1, oxetanes and cyclic ureas in EP 1 199 327 A2 and morpholine-2,3-dione and its derivatives in WO 2003/031482 A1.

Preferred surface postcrosslinkers are glycerol, ethylene carbonate, ethylene glycol diglycidyl ether, reaction products of polyamides with epichlorohydrin, and mixtures of propylene glycol and 1,4-butanediol.

Very particularly preferred surface postcrosslinkers are 2-hydroxyethyloxazolidin-2-one, oxazolidin-2-one and 1,3-propanediol.

In addition, it is also possible to use surface postcrosslinkers which comprise additional polymerizable ethylenically unsaturated groups, as described in DE 37 13 601 A1.

The amount of surface postcrosslinkers is preferably 0.001 to 2% by weight, more preferably 0.02 to 1% by weight, most preferably 0.05 to 0.2% by weight, based in each case on the polymer particles.

In a preferred embodiment of the present invention, polyvalent cations are applied to the particle surface in addition to the surface postcrosslinkers before, during or after the surface postcrosslinking.

The polyvalent cations usable in the process according to the invention are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are chloride, bromide, sulfate, hydrogensulfate, carbonate, hydrogencarbonate, nitrate, phosphate, hydrogenphosphate, dihydrogenphosphate and carboxylate, such as acetate and lactate. Aluminum sulfate and aluminum lactate are preferred. Apart from metal salts, it is also possible to use polyamines as polyvalent cations.

The amount of polyvalent cation used is, for example, 0.001 to 1.5% by weight, preferably 0.005 to 1% by weight, more preferably 0.02 to 0.8% by weight, based in each case on the polymer particles.

The surface postcrosslinking is typically performed in such a way that a solution of the surface postcrosslinker is sprayed onto the dried polymer particles. After the spraying, the polymer particles coated with surface postcrosslinker are dried thermally, and the surface postcrosslinking reaction can take place either before or during the drying.

The spraying of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; US) and Schugi Flexomix® (Hosokawa Micron BV; Doetinchem; the Netherlands). However, it is also possible to spray on the surface postcrosslinker solution in a fluidized bed.

The surface postcrosslinkers are typically used in the form of an aqueous solution. The content of nonaqueous solvent and/or total amount of solvent can be used to adjust the penetration depth of the surface postcrosslinker into the polymer particles.

When exclusively water is used as the solvent, a surfactant is advantageously added. This improves the wetting performance and reduces the tendency to form lumps. However, preference is given to using solvent mixtures, for example isopropanol/water, 1,3-propanediol/water and propylene glycol/water, where the mixing ratio by mass is preferably from 20:80 to 40:60.

The thermal drying is preferably carried out in contact driers, more preferably paddle driers, most preferably disk driers. Suitable driers are, for example, Hosokawa Bepex® horizontal paddle driers (Hosokawa Micron GmbH; Leingarten; Germany), Hosokawa Bepex® disk driers (Hosokawa Micron GmbH; Leingarten; Germany) and Nara paddle driers (NARA Machinery Europe; Frechen; Germany). Moreover, it is also possible to use fluidized bed driers.

The drying can be effected in the mixer itself, by heating the jacket or blowing in warm air. Equally suitable is a downstream drier, for example a shelf drier, a rotary tube oven or a heatable screw. It is particularly advantageous to mix and dry in a fluidized bed drier.

Preferred drying temperatures are in the range of 100 to 250° C., preferably 120 to 220° C., more preferably 130 to 210° C., most preferably 150 to 200° C. The preferred residence time at this temperature in the reaction mixer or drier is preferably at least 10 minutes, more preferably at least 20 minutes, most preferably at least 30 minutes, and typically at most 60 minutes.

Subsequently, the surface postcrosslinked polymer particles can be classified again, excessively small and/or excessively large polymer particles being removed and recycled into the process.

To further improve the properties, the surface postcrosslinked polymer particles are coated or remoisturized. Suitable coatings for improving the swell rate and the permeability (SFC) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, and surfactants, such as Span® 20.

Suitable inorganic inert substances are silicates such as montmorillonite, kaolinite and talc, zeolites, activated carbons, polysilicic acids, magnesium carbonate, calcium carbonate, barium sulfate, aluminum oxide, titanium dioxide and iron(II) oxide. Preference is given to using polysilicic acids which, according to the method of preparation, are distinguished between precipitated silicas and fumed silicas. Both variants are commercially available under the names Silica FK, Sipernat®, Wessalon® (precipitated silicas) and Aerosil® (fumed silicas). The inorganic inert substances can be used as a dispersion in an aqueous or water-miscible dispersant.

When the water-absorbing polymer particles are coated with an inorganic inert material, the amount of inorganic inert material used, based on the water-absorbing polymer particles, is preferably from 0.05 to 5% by weight, more preferably from 0.1 to 1.5% by weight, most preferably from 0.3 to 1% by weight.

Suitable organic materials are polyalkyl methacrylates or thermoplastics such as polyvinyl chloride.

Suitable cationic polymers are polyalkylenepolyamines, cationic derivatives of polyacrylamides, polyethylenimines and polyquaternary amines.

Polyquaternary amines are, for example, condensation products formed from hexamethylenediamine, dimethylamine and epichlorohydrin, condensation products formed from dimethylamine and epichlorohydrin, copolymers formed from hydroxyethylcellulose and diallyldimethylammonium chloride, copolymers formed from acrylamide and α-methacryloyloxyethyltrimethylammonium chloride, condensation products formed from hydroxyethylcellulose, epichlorohydrin and trimethylamine, homopolymers of diallyldimethylammonium chloride and addition products of epichlorohydrin onto amidoamines. In addition, it is possible to obtain polyquaternary amines by reaction of dimethyl sulfate with polymers such as polyethylenimines, copolymers formed from vinylpyrrolidone and dimethylaminoethyl methacrylate, or copolymers formed from ethyl methacrylate and diethylaminoethyl methacrylate. The polyquaternary amines are available within a wide molecular weight range.

However, it is also possible to obtain the cationic polymers on the particle surface, either by means of reagents which can form a network with themselves, such as addition products of epichlorohydrin onto polyamidoamines, or by the application of cationic polymers which can react with an added crosslinker, such as polyamines or polyimines in combination with polyepoxides, polyfunctional esters, polyfunctional acids or polyfunctional (meth)acrylates.

It is possible to use all polyfunctional amines with primary or secondary amino groups, such as polyethylenimine, polyallylamine and polylysine. The liquid sprayed in the process according to the invention preferably comprises at least one polyamine, for example polyvinylamine.

The cationic polymers can be used as a solution in an aqueous or water-miscible solvent, as a dispersion in an aqueous or water-miscible dispersant or in bulk.

When the water-absorbing polymer particles are coated with a cationic polymer, the amount of cationic polymer used, based on the water-absorbing polymer particles, is preferably from 0.1 to 15% by weight, more preferably from 0.5 to 10% by weight, most preferably from 1 to 5% by weight.

When the water-absorbing polymer particles are coated with a cationic polymer, the residence time of the water-absorbing polymer particles in the course of spray application of the cationic polymer is preferably from 2 to 50%, more preferably from 5 to 30%, most preferably from 10 to 25%, of the total residence time in the mixer.

Suitable di- or polyvalent metal cations are Mg²⁺, Ca²⁺, Al³⁺, Sc³⁺, Ti⁴⁺, Mn²⁺, Fe^{2+/3+}, Co²⁺, Ni²⁺, Cu^{+/2+}, Zn²⁺, Y³⁺, Zr⁴⁺, Ag⁺, La³⁺, Ce⁴⁺, Hf⁴⁺ and Au^{+/3+}, preferred metal cations being Mg²⁺, Ca²⁺, Al³⁺, Ti⁴⁺, Zr⁴⁺ and La³⁺, particularly preferred metal cations being Al³⁺, Ti⁴⁺ and Zr⁴⁺. The metal cations can be used either alone or in a mixture with one another. Among the metal cations mentioned, all metal salts which possess a sufficient solubility in the solvent for use are suitable. Particularly suitable metal salts are those with weakly complexing anions, such as chloride, nitrate and sulfate. The metal salts are preferably used as a solution. The solvents used for the metal salts may be water, alcohols, dimethylformamide, dimethyl sulfoxide and mixtures thereof. Particular preference is given to water and water/alcohol mixtures, such as water/methanol or water/propylene glycol.

The liquid sprayed in the process according to the invention preferably comprises at least one polyvalent metal cation, for example Al³⁺.

When the water-absorbing polymer particles are coated with a polyvalent metal cation, the amount of polyvalent metal cation used, based on the water-absorbing polymer particles, is preferably from 0.05 to 5% by weight, more preferably from 0.1 to 1.5% by weight, most preferably from 0.3 to 1% by weight.

When the water-absorbing polymer particles are coated with a polyvalent metal cation, the residence time of the water-absorbing polymer particles in the course of spray application of the polyvalent metal cation is preferably from 1 to 30%, more preferably from 2 to 20%, most preferably from 5 to 15%, of the total residence time in the mixer. Advantageously, the polyvalent metal cation is metered in before the cationic polymer.

Particularly suitable polyols are polyethylene glycols having a molecular weight of 400 to 20 000 g/mol, polyglycerol, 3- to 100-tuply ethoxylated polyols, such as trimethylolpropane, glycerol, sorbitol and neopentyl glycol. Particularly suitable are 7- to 20-tuply ethoxylated glycerol or trimethylolpropane, for example Polyol TP 70® (Perstorp AB, Perstorp, Sweden). The latter especially have the advantage that they lower the surface tension of an aqueous extract of the water-absorbing polymer particles only insignificantly. The polyols are preferably used as a solution in aqueous or water-miscible solvents.

The liquid sprayed in the process according to the invention preferably comprises at least one polyol, for example polyethylene glycol.

When the water-absorbing polymer particles are coated with a polyol, the amount of polyol used, based on the water-absorbing polymer particles, is preferably from 0.005 to 2% by weight, more preferably from 0.01 to 1% by weight, most preferably from 0.05 to 0.5% by weight.

When the water-absorbing polymer particles are coated with a polyol, the residence time of the water-absorbing polymer particles in the course of spray application of the polyol is preferably from 20 to 80%, more preferably from 30 to 70%, most preferably from 40 to 60%, of the total residence time in the mixer. The polyol is advantageously metered in after the cationic polymer.

The water-absorbing polymer particles produced by the process according to the invention have a moisture content of preferably 1 to 15% by weight, more preferably 1.5 to 10% by weight, most preferably 2 to 8% by weight, the water content being determined by EDANA recommended test method No. WSP 230.2-05 “Moisture Content”.

The water-absorbing polymer particles produced by the process according to the invention have a centrifuge retention capacity (CRC) of typically at least 15 g/g, preferably at least 20 g/g, preferentially at least 22 g/g, more preferably at least 24 g/g, most preferably at least 26 g/g. The centrifuge retention capacity (CRC) of the water-absorbing polymer particles is typically less than 60 g/g. The centrifuge retention capacity (CRC) is determined by EDANA recommended test method No. WSP 241.2-05 “Centrifuge Retention Capacity”.

The water-absorbing polymer particles produced by the process according to the invention have an absorption under a pressure of 63.0 g/cm² of typically at least 10 g/g, preferably at least 15 g/g, preferentially at least 18 g/g, more preferably at least 20 g/g, most preferably at least 22 g/g. The absorption under a pressure of 63.0 g/cm² of the water-absorbing polymer particles is typically less than 35 g/g. The absorption under a pressure of 63.0 g/cm² is determined analogously to EDANA recommended test method No. WSP 242.2-05 “Absorption under Pressure”, except that a pressure of 63.0 g/cm² is established instead of a pressure of 21.0 g/cm².

The water-absorbing polymer particles are tested by means of the test methods described below.

### Methods:

The measurements should, unless stated otherwise, be carried out at an ambient temperature of 23±2° C. and a relative air humidity of 50±10%. The water-absorbing polymer particles are mixed thoroughly before the measurement.

### Saline Flow Conductivity

The saline flow conductivity (SFC) of a swollen gel layer under a pressure of 0.3 psi (2070 Pa) is, as described in EP 0 640 330 A1, determined as the gel layer permeability of a swollen gel layer of water-absorbing polymer particles, the apparatus described on page 19 and in FIG. 8 in the aforementioned patent application having been modified to the effect that the glass frit (40) is not used, and the plunger (39) consists of the same polymer material as the cylinder (37) and now comprises 21 bores of equal size distributed homogeneously over the entire contact area. The procedure and evaluation of the measurement remain unchanged from EP 0 640 330 A1. The flow is detected automatically.

The saline flow conductivity (SFC) is calculated as follows:

SFC [cm³s/g]=(Fg(t=0)×L0)/(d×A×WP)

where Fg(t=0) is the flow of NaCl solution in g/s, which is obtained using linear regression analysis of the Fg(t) data of the flow determinations by extrapolation to t=0, L0 is the thickness of the gel layer in cm, d is the density of the NaCl solution in g/cm³, A is the area of the gel layer in cm², and WP is the hydrostatic pressure over the gel layer in dyn/cm².

### Dust Count

The dust count of the water-absorbing polymer particles is determined with the aid of the DustView dust measuring instrument (Palas GmbH, Karlsruhe, Germany).

The mechanical part of the measuring instrument consists of a charging funnel with flap, downpipe and dust casing with removable dust box.

The determination of the dust count quantitatively records dusting fractions of solids which arise after defined stress on the material (free fall and collision).

The evaluation is effected by optoelectronic means. The dusting solids content leads to the attenuation of a light beam, which is recorded photometrically. The measurement is registered and evaluated in the control unit. The following measurements are indicated as numerical values on the control unit:

1. measurement after 0.5 second (maximum value)
2. measurement after 30 seconds (dust value)
3. dust count (sum of maximum value and dust value)

The dust counts are rated as follows:

| | | |
|---|---|---|
| dust count | 25-100 | dusting to highly dusting |
| dust count | 12-25 | low-dusting to dusting |
| dust count | 1-12 | low-dusting to virtually dust-free |
| dust count | ≦1 | dust-free |

### Particle Size Distribution (PSD)

The particle size distribution of the water-absorbing polymer particles is determined analogously to EDANA recommended test method No. WSP 220.2-05 “Particle size distribution”.

### Centrifuge Retention Capacity

The centrifuge retention capacity (CRC) is determined by EDANA recommended test method No. WSP 241.2-05 “Centrifuge Retention Capacity”.

Absorption Under a Pressure of 63.0 g/cm²

The absorption under a pressure of 63.0 g/cm² (AUL0.9 psi) of the water-absorbing polymer particles is determined analogously to EDANA recommended test method No. WSP 242.2-05 “Absorption under Pressure”, except that a pressure of 63.0 g/cm² (AUL0.9 psi) is established instead of a pressure of 21.0 g/cm² (AUL0.3 psi).

### Extractables

The proportion of extractables of the water-absorbing polymer particles is determined by EDANA recommended test method No. WSP 270.2-05 “Extractables”.

The EDANA test methods are obtainable, for example, from EDANA, Avenue Eugene Plasky 157, B-1030 Brussels, Belgium.

### EXAMPLES

### Example 1

By continuously mixing deionized water, 50% by weight sodium hydroxide solution and acrylic acid, an acrylic acid/sodium acrylate solution is prepared, such that the degree of neutralization corresponds to 65 mol %. The solids content of the monomer solution was 40% by weight.

The polyethylenically unsaturated crosslinker used was polyethylene glycol-400 diacrylate (diacrylate proceeding from a polyethylene glycol with a mean molar mass of 400 g/mol). The amount used was 1.35 kg per kg of monomer solution.

To initiate the free-radical polymerization, per kg of monomer solution, 5.11 g of a 0.33% by weight aqueous hydrogen peroxide solution, 6.31 g of a 15% by weight aqueous sodium peroxodisulfate solution and 4.05 g of a 0.5% by weight aqueous ascorbic acid solution were used.

The throughput of the monomer solution was 1200 kg/h. The reaction solution had a temperature of 23.5° C. at the feed.

The individual components were metered in the following amounts continuously into a List ORP 250 Contikneter continuous kneader reactor (LIST AG, Arisdorf, Switzerland):

| | |
|---|---|
| 1200 kg/h | of monomer solution |
| 1.620 kg/h | of polyethylene glycol-400 diacrylate |
| 13.704 kg/h | of hydrogen peroxide solution/sodium peroxodisulfate |
| | solution |
| 4.860 kg/h | of ascorbic acid solution |

Between the addition point for crosslinker and the addition sites for the initiators, the monomer solution was inertized with nitrogen.

After approx. 50% of the residence time, a metered addition of fines (45 kg/h), which were obtained from the production process by grinding and sieving, to the reactor additionally took place. The residence time of the reaction mixture in the reactor was 15 minutes.

The resulting product gel was placed onto a belt dryer. On the belt dryer, an air/gas mixture flowed continuously around the polymer gel and dried it at 175° C. The residence time in the belt dryer was 43 minutes.

The dried polymer gel was ground and sieved off to a particle size fraction of 150 to 850 μm. The base polymer thus obtained had the following properties:

### CRC: 32 g/g

### AUL0.3 psi: 26 g/g

Extractables: 9.8% by weight
pH: 5.8

In a Schugi FX 160 Flexomix® (Hosokawa-Micron B.V., Doetinchem, the Netherlands), the base polymer was coated with the surface postcrosslinking solution and then dried directly in a NARA NPD 5W8 paddle dryer (GMF Gouda, Waddinxveen, the Netherlands) at 190° C. for 45 minutes.

The following amounts were metered into the Schugi Flexomix®:

| | |
|---|---|
| 500 kg/h | of base polymer |
| 25.0 kg/h | of surface postcrosslinking solution |

The surface postcrosslinking solution comprised 2.0% by weight of N-hydroxyethyl-2-oxazolidinone, 97.5% by weight of deionized water and 0.5% by weight of sorbitan monococoate.

The surface postcrosslinked polymer particles were subsequently cooled to approx. 60° C. in a NARA NPD 3W9 paddle cooler (GMF Gouda, Waddinxveen, the Netherlands) and then sieved off once again to a particle size fraction of 150 to 850 μm.

The surface postcrosslinked water-absorbing polymer particles used have the following profile of properties:

### CRC: 26.5 g/g

### AUL0.9 psi: 21 g/g

SFC: 120×10⁻⁷ cm³s/g
Extractables: 7.8% by weight

| | | |
|---|---|---|
| >850 | μm | 0.7% by weight |
| 600-850 | μm | 31.3% by weight |
| 300-600 | μm | 50.5% by weight |
| 90-300 | μm | 17.3% by weight |
| <90 | μm | 0.2% by weight |

### Example 2

The surface postcrosslinked water-absorbing polymer particles were coated in a Ruberg DLM 350-1500 continuous flow mixer (Gebrüder Ruberg GmbH & Co KG, Nieheim, Germany) by means of an RZD1-H two-substance nozzle (Gebruder Ruberg GmbH & Co KG, Nieheim, Germany) with a 50% by weight aqueous solution of Lupamin® 9095 (BASF Aktiengesellschaft, Ludwigshafen, Germany). Lupamin® 9095 is a high molecular weight linear polyvinylamine.

The continuous flow mixer was set up horizontally (0° slope) and had an air-purged seal. The mixing chamber volume was 140 l. The fill level of the continuous flow mixer was 60%, and the speed of rotation was 43 min⁻¹. The Froude number of the moving surface postcrosslinked water-absorbing polymer particles was 0.36.

The two-substance nozzle was installed horizontally. The distance from the end wall of the continuous flow mixer was 375 mm, and the horizontal distance of the nozzle mouth from the mixer wall was 50 mm. The nozzle head was 150 mm below the product bed surface. The spray nozzle had electrical trace heating. The trace heating was regulated such that the nozzle temperature was 60° C. The pressure of the atomizer gas (nitrogen) was 4.8 bar. The throughput of atomizer gas was 12 kg/h.

The throughput of water-absorbing polymer particles was 180 kg/h. The temperature of the water-absorbing polymer particles was 60° C.

The throughput of the coating solution was 7.2 kg/h. The temperature of the coating solution was 60° C.

A continuous flow mixer provided with an antiadhesive coating (polytetrafluoroethylene; contact angle 110°) and an uncoated continuous flow mixer (contact angle 26°) were used. The inner wall of the uncoated continuous flow mixer was made from stainless steel (materials number 1.4571). The continuous flow mixer was operated for several hours without disruption.

The coated water-absorbing polymer particles were analyzed. The results are compiled in table 1.

TABLE 1
Coating with Lupamin ® 9095

| | | coated polymer | |
|---|---|---|---|
| | uncoated | particles mixer | coated polymer |
| | polymer | with antiadhesive | particles |
| | particles | coating | uncoated mixer |
| CRC [g/g] | 27 | 26 | 27 |
| AUL0.9 psi [g/g] | 21 | 19 | 20 |
| SFC [10⁻⁷ cm³s/g] | 130 | 280 | 390 |
| >850 μm | 0.7% by wt. | 14% by wt. | 0.8% by wt. |

### Example 3

The procedure was as in example 2. In addition, by means of a second two-substance nozzle, coating was effected with a 20% by weight aqueous solution of polyethylene glycol 400 (polyethylene glycol with a mean molar mass of 400 g/mol).

The second two-substance nozzle was likewise installed horizontally. The distance from the end wall of the continuous flow mixer was 750 mm, and the horizontal distance of the nozzle mouth from the mixer wall was 50 mm. The nozzle head was immersed completely into the water-absorbing polymer particles.

The throughput of the second coating solution was 1.35 kg/h. The temperature of the coating solution was 20° C.

The coated water-absorbing polymer particles were analyzed. The results are compiled in table 2.

TABLE 2
Coating with Lupamin ® 9095 and polyethylene glycol 400

| | | coated polymer | |
|---|---|---|---|
| | | particles | |
| | uncoated | mixer with | coated polymer |
| | polymer | antiadhesive | particles |
| | particles | coating | uncoated mixer |
| CRC [g/g] | 27 | 26 | 26 |
| AUL0.9 psi [g/g] | 21 | 21 | 21 |
| SFC [10⁻⁷ cm³s/g] | 130 | 170 | 190 |
| Dust count | 3-4 | 1-2 | <0 |

### Example 4

The procedure was as in example 3. In addition, by means of a third two-substance nozzle, coating was effected with a 23.9% by weight aqueous solution of aluminum sulfate.

The third two-substance nozzle was likewise installed horizontally. The distance from the end wall of the continuous flow mixer was 150 mm, and the horizontal distance of the nozzle mouth from the mixer wall was 50 mm. The nozzle head was immersed completely into the water-absorbing polymer particles.

The throughput of the third coating solution was 7.2 kg/h. The temperature of the coating solution was 20° C.

The coated water-absorbing polymer particles were analyzed. The results are compiled in table 3.

TABLE 3
Coating with Lupamin ® 9095, polyethylene glycol 400 and aluminum
sulfate

| | | coated polymer | |
|---|---|---|---|
| | | particles | |
| | uncoated | mixer with | coated polymer |
| | polymer | antiadhesive | particles |
| | particles | coating | uncoated mixer |
| CRC [g/g] | 27 | 24 | 23 |
| AUL0.9 psi [g/g] | 21 | 17 | 17 |
| SFC [10⁻⁷ cm³s/g] | 130 | 410 | 460 |

### Example 5

The roughness and the contact angle with respect to water of various stainless steels were examined. The results are compiled in table 4:

TABLE 4
Surface roughness and contact angle

| | Surface roughness | Contact angle |
|---|---|---|
| Materials number 1.4541 | | |
| untreated (matt) | 3.048 μm | 74.0° |
| polished | 0.789 μm | 21.0° |
| roughened (120 grit) | 1.708 μm | 69.7° |
| Materials number 1.4571 | | |
| untreated (matt) | 1.332 μm | 62.3° |
| polished | 0.368 μm | 25.7° |
| roughened (120 grit) | 1.761 μm | 67.7° |

1. A process for preparing water-absorbing polymer particles by polymerizing a monomer solution or suspension comprising
a) at least one ethylenically unsaturated monomer which bears an acid group and may be at least partly neutralized,
b) at least one crosslinker,
c) at least one initiator,
d) optionally one or more ethylenically unsaturated monomer copolymerizable with the monomer mentioned under a) and
e) optionally one or more water-soluble polymer, comprising drying, grinding, classifying, and surface postcrosslinking, an aqueous liquid being sprayed onto the surface postcrosslinked water-absorbing polymer particles by at least one spray nozzle in a continuous horizontal mixer with moving mixing tools, wherein an inner wall of the mixer in contact with the product has a contact angle of less than 80° with respect to water.

2. The process according to claim 1, wherein the water-absorbing polymer particles have been surface postcrosslinked by formation of covalent bonds.

3. The process according to claim 1, wherein polyvalent cations have been used additionally in the surface postcrosslinking.

4. The process according to claim 1, wherein the inner wall of the mixer in contact with the product is made from a stainless steel.

5. The process according to claim 1, wherein the water-absorbing polymer particles fed to the mixer have a temperature of 40 to 80° C.

6. The process according to claim 1, wherein a residence time of the water-absorbing polymer particles in the mixer is from 1 to 180 minutes.

7. The process according to claim 1, wherein a peripheral speed of the mixing tools in the mixer is from 0.1 to 10 m/s, and the water-absorbing polymer particles in the mixer are moved at a speed which corresponds to a Froude number of 0.01 to 6.

8. The process according to claim 1, wherein a fill level of the mixer is from 30 to 80% and the liquid is sprayed at least 10 mm below a product bed surface.

9. The process according to claim 1, wherein the at least one spray nozzle is trace-heated.

10. The process according to claim 1, wherein the water-absorbing polymer particles have a centrifuge retention capacity of at least 15 g/g.
